(19) United States
(12) Patent Application Publication
(10) Pub. No.: US 2012/0250029 A1
(43) Pub. Date: Oct. 4, 2012

(54) OPTICAL TOMOGRAPHIC IMAGING APPARATUS AND CONTROL METHOD THEREFOR

(75) Inventor: Hirofumi Yoshida, Yokohama-shi (JP)

(73) Assignee: CANON KABUSHIKI KAISHA, Tokyo (JP)

(21) Appl. No.: 13/428,208

(22) Filed: Mar. 23, 2012

(30) Foreign Application Priority Data
Mar. 31, 2011 (JP) 2011-077091
Mar. 21, 2012 (JP) 2012-063897

(51) Int. Cl. G01B 11/02

(52) U.S. Cl. 356/497

(57) ABSTRACT

To remove an artifact generated by coherent noise from a tomographic image, provided is an optical tomographic imaging apparatus including: an artifact acquiring unit for acquiring an artifact generated by interference among a plurality of reflected light beams reflected by a plurality of layers of the object to be inspected; and an acquiring unit for acquiring a second tomographic image of the object to be inspected based on the artifact and a first tomographic image of the object to be inspected.

### BACKGROUND OF THE INVENTION

1. Field of the Invention

The present invention relates to an optical tomographic imaging apparatus and a control method therefor, and more particularly, to an optical tomographic imaging apparatus that is used for ophthalmologic diagnosis and treatment, and a control method therefor.

2. Description of the Related Art

Currently, there are various types of ophthalmologic apparatus using an optical apparatus. For instance, as an optical apparatus for monitoring an eye, there are used various apparatus such as an anterior eye part imaging apparatus, a fundus camera, and a confocal laser scanning ophthalmoscope (scanning laser ophthalmoscope: SLO). In particular, an optical tomographic imaging apparatus that performs optical coherence tomography (OCT) utilizing an interference phenomenon of multi-wavelength light is an apparatus capable of obtaining a tomographic image of a sample with high resolution. For this reason, the optical tomographic imaging apparatus is becoming an indispensable apparatus as an ophthalmologic apparatus for a specialist of retina in the outpatient field. Hereinbelow, the optical tomographic imaging apparatus is referred to as an OCT apparatus.

In the above-mentioned OCT apparatus, measuring light that is low coherence light is projected to a sample, and backscattering light from the sample may be measured with high sensitivity by using an interference system or an interference optical system. In addition, the OCT apparatus is capable of obtaining a tomographic image with high resolution by scanning the sample with the measuring light. With this, a tomographic image of a retina in the fundus of an eye to be inspected is acquired. The OCT apparatus is used widely for ophthalmologic diagnosis of retina or the like.

On the other hand, if there is a plurality of high reflection layers in an object to be inspected when a tomographic image is acquired, light beams reflected by the plurality of high reflection layers are interfered with each other. As a result, artifact may occur in the tomographic image at a place where no structure should exist. This artifact is called coherent noise. The coherent noise is the interference in the object to be inspected as described above and occurs more conspicuously as reflectance in the object to be inspected is higher and sensitivity of the OCT apparatus is higher, which is the feature of the coherent noise. In addition, a position of the high reflection layer is different among objects to be inspected, and hence another feature is that the position and intensity of the coherent noise are different for each measurement.

“Coherent noise-free ophthalmic imaging by spectral optical coherence tomography”, J. Phys. D, Appl. Phys. 38, 2005, pp. 2606-2611 describes one method for reducing coherent noise by lowering the sensitivity of an OCT apparatus in the design stage.

In addition, Japanese Patent Application Laid-Open No. 2010-038910 describes the removal of autocorrelation components in tomographic images rather than the coherent noise.

In “Coherent noise-free ophthalmic imaging by spectral optical coherence tomography”, J. Phys. D, Appl. Phys. 38, 2005, pp. 2606-2611, the sensitivity of the OCT apparatus is reduced in the design stage, and the coherent noise is set to the same level as a noise level of background, so as to reduce the coherent noise. Thus, it is possible to make the coherent noise less conspicuous.

However, the sensitivity of the OCT apparatus is sacrificed because the sensitivity of the OCT apparatus is reduced in the design stage, and hence a signal to be essentially acquired as an OCT image is reduced similarly. Therefore, there may occur a problem that a structure to be observed cannot be acquired clearly.

On the other hand, in Japanese Patent Application Laid-Open No. 2010-038910, autocorrelation components are removed using a light transmittance controlling unit disposed in each of a measuring optical path and a reference optical path. As to the autocorrelation component, uniform intensity can be obtained at a 0 delay position regardless of a place of the object to be inspected, and hence the autocorrelation can be removed by measuring only a variation with time. However, the coherent noise cannot be substantially removed because its luminance is different among places of the object to be inspected and because the coherent noise does not always occur.

### SUMMARY OF THE INVENTION

In view of the above-mentioned problem, it is an object of the present invention to provide an optical tomographic imaging apparatus and a control method therefor, in which coherent noise that is different among places is eliminated without reducing a signal to be essentially acquired as an OCT image so that a tomographic image without coherent noise can be acquired.

The present invention provides an optical tomographic imaging apparatus having the following structure.

That is, the present invention provides an optical tomographic imaging apparatus for acquiring a tomographic image of an object to be inspected based on combined light in which return light from the object to be inspected that is illuminated by measuring light and reference light corresponding to the measuring light are combined, the optical tomographic imaging apparatus including: an artifact acquiring unit for acquiring an artifact generated by interference among a plurality of reflected light beams reflected by a plurality of layers of the object to be inspected; and an acquiring unit for acquiring a second tomographic image of the object to be inspected based on the artifact and a first tomographic image of the object to be inspected.

According to the present invention, it is possible to provide an OCT image without any artifact by removing coherent noise generated by interference among a plurality of reflected light beams reflected by a plurality of layers in a fundus portion, without reducing sensitivity of the OCT apparatus.

Further features of the present invention will become apparent from the following description of exemplary embodiments with reference to the attached drawings.

### BRIEF DESCRIPTION OF THE DRAWINGS

FIG. 1 is a diagram illustrating a structure of an optical tomographic imaging apparatus according to a first embodiment and a second embodiment of the present invention.

FIG. 2A is a diagram illustrating a state in which an eye to be inspected is observed when a tomographic image of the OCT apparatus is acquired according to the first embodiment and the second embodiment of the present invention.

FIG. 2B is a diagram illustrating an example of a tomographic image of the eye to be inspected.

FIG. 2C is a diagram illustrating a state in which a raster scan of a retina is performed with measuring light.

FIG. 3A is a diagram illustrating a fundus tomographic image and coherent noise according to the first embodiment of the present invention, and illustrates a case where coherent noise appears on the tomographic image.

FIG. 3B is a diagram illustrating a case where coherent noise does not appear on the tomographic image.

FIG. 3C is a diagram illustrating an image acquired only by the measuring light and by blocking reference light.

FIG. 4 is a measurement flow according to the first embodiment of the present invention.

FIG. 5A is a timing chart according to the first embodiment of the present invention.

FIG. 5B is a timing chart when measurement is performed by sequentially switching a pre-scan and a main scan.

FIG. 6A is a diagram illustrating a method of scanning the retina according to the first embodiment of the present invention, and is a schematic diagram in a case where coherent noise appears on the tomographic image.

FIG. 6B is a schematic diagram in a case where coherent noise does not appear in contrast to FIG. 6A.

FIGS. 7A, 7B, 7C and 7D are diagrams illustrating a fundus tomographic image and coherent noise according to the second embodiment of the present invention.

FIG. 8 is a measurement flow according to the second embodiment of the present invention.

### DESCRIPTION OF THE EMBODIMENTS

An optical tomographic imaging apparatus of one embodiment of the present invention can acquire an artifact on the basis of a coherent noise in a state wherein a tomographic image of an object to be inspected which has a plurality of layers (such as a multiple layers of a retina does not exist in a display area of a display unit (imaging frame). Note that the coherent noise is a noise generated by interfering a plurality reflection light reflected by each of the plurality layers. The artifact can be call as a vertical image. In addition, an optical tomographic image of other embodiment of the present invention can acquire the artifact on the basis of the coherent noise by the tomographic images at different positions in a display area of the display unit (tomographic images with different artifacts). As the result, the artifact based on the coherent noise can be subtracted from the tomographic image (which can be called as a first image) and the tomgraphic image (which can be called as a second image) with low noise can be acquired. Hereinafter, exemplary embodiments of the present invention are described.

### First Embodiment

### Acquiring a Vertical Image from Coherent Noise by Reducing a Reference Light

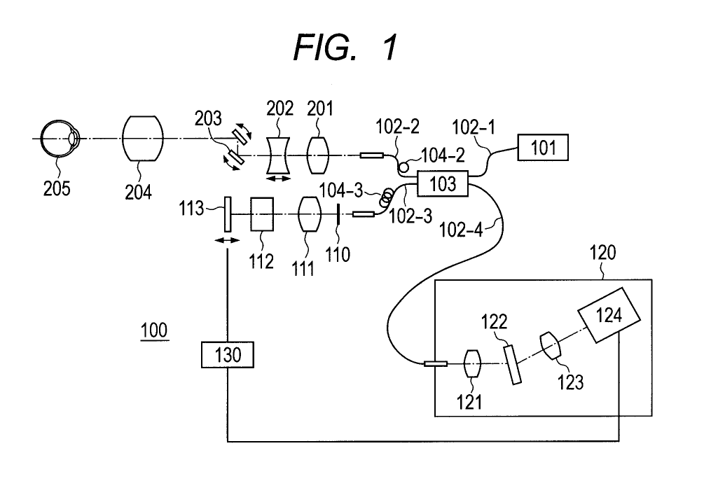

In a first embodiment of the present invention, an optical tomographic imaging apparatus (OCT apparatus) to which the present invention is applied is described with reference to FIG. 1.

An OCT apparatus 100 of this embodiment constitutes a Michelson interferometer as a whole as illustrated in FIG. 1. The OCT apparatus 100 has a structure including an OCT system. In the OCT system, light emitted from a light source is first split into measuring light and reference light. Then, the measuring light is guided to a measuring optical path and an object to be inspected so that return light is obtained. This return light from the measuring light and the reference light via the reference optical path are combined and interfered so as to obtain combined light. Through use of this combined light, a tomographic image of the object to be inspected is acquired.

Specifically, in FIG. 1, the light emitted from a light source 101 is guided by a single mode fiber 102-1 to enter an optical coupler 103, and is split by the optical coupler 103 into the reference light of a reference optical path 102-3 and the measuring light of a measuring optical path 102-2.

The measuring light of the measuring optical path 102-2 out of the two split optical paths is reflected or scattered by a retina or the like of the eye 205 to be inspected as an object to be observed and inspected, and returns as return light. Then, the return light is combined by the optical coupler 103 with the reference light of the reference optical path 102-3 propagating via the reference optical path, which is guided to a combined optical path 102-4 to be combined light. After the combining, the combined light enters a spectroscope 120. The combined light is split by a transmission diffraction grating 122 into spectra of wavelengths, which enter a line sensor 124. The line sensor 124 converts light intensity at each position (wavelength) into a voltage. Through use of the voltage signals, a tomographic image of the eye 205 to be inspected, in particular, a tomographic image of the fundus portion is formed.

Next, a peripheral portion of the light source 101 is described. The light source 101 is a super luminescent diode (SLD), which is a typical low coherence light source. The light source 101 has a wavelength of 855 nm and a bandwidth of 100 nm. Here, the bandwidth is an important parameter because the bandwidth affects the resolution of the obtained tomographic image in the optical axis direction. In addition, the light source of an SLD type is used in this embodiment, but an amplified spontaneous emission (ASE) type or the like may also be used as long as the light source emits a low coherence beam. In addition, concerning the wavelength of light, near-infrared light is suitable because the light is used for measuring an eye. Further, the wavelength affects the resolution of the obtained tomographic image in the lateral direction, and hence the wavelength is desirably as short as possible. Here, the wavelength is 855 nm. Depending on the measurement site to be monitored, another wavelength may be selected.

Next, the reference optical path 102-3 is described. The reference light of the reference optical path 102-3 split by the optical coupler 103 passes through a polarization controller 104-3, and the resultant beams are converted into substantially parallel beams by the lens 111, and are then emitted. A light blocking portion 110 is disposed on the coupler side of the lens 111 and can block the reference light. The light blocking portion 110 is disposed on the reference optical path and temporarily prevents the reference light from returning to the optical coupler 103 by blocking the reference light. Next, the reference light passes through a dispersion compensation glass 112 and enters a reference mirror 113. Next, the reference light is changed in direction by the mirror 113 and is directed to the optical coupler 103 again. Next, the reference light passes through the optical coupler 103 and is guided to the line sensor 124. Here, the dispersion compensation glass 112 compensates the dispersion with respect to the reference light when the measuring light propagates back and forth between the eye 205 to be inspected and a scanning optical system. Further, the reference mirror 113 can be moved in the direction indicated by the arrow of FIG. 1 so as to adjust and control an optical path length of the reference light.

Next, an optical path of the measuring optical path 102-2 is described. The measuring light split by the optical coupler 103 passes through a polarization controller 104-2 and passes through lenses 201 and 202. The lens 202 can be moved in the direction indicated by the arrow of FIG. 1, and condenses the measuring light onto a desired layer of the retina of the eye 205 to be inspected so as to enable the observation of the desired layer. In addition, it is possible to support a case where the eye 205 to be inspected has a refractive error.

The measuring light that has passed the lenses 201 and 202 enters a mirror of an XY scanner 203 constituting the scanning optical system. With the measuring light, the XY scanner 203 performs raster scan of the retina of the eye 205 to be inspected in the direction orthogonal to the optical axis. The lens 204 is an optical system for the measuring light to scan the retina of the eye 205 to be inspected. The lens 204 is configured to form an image of the measuring light on an arbitrary position of the retina.

The XY scanner 203 is driven about the arbitrary position as a center so as to acquire each scan image. When the measuring light enters the eye 205 to be inspected, the measuring light is reflected or scattered by the retina and becomes the return light, which passes through the optical coupler 103 and is guided to the line sensor 124.

Note that, the above-mentioned operation of the XY scanner 203, a variation of the optical path length of the reference light due to the movement of the reference mirror 113, and the following processing performed on the signal obtained by the line sensor 124, and the like are performed by a control device or unit 130 such as a PC.

With the structure described above, the measuring light can scan the retina of the eye 205 to be inspected.

Next, a structure of the spectroscope 120 in the OCT apparatus of this embodiment is described. The return light reflected or scattered by the retina of the eye 205 to be inspected and the reference light are combined by the optical coupler 103. Then, the combined light is emitted from a fiber end of an optical fiber as the combined optical path 102-4 and is collimated by a lens 121 to be substantially parallel light. This substantially parallel light illuminates the transmission diffraction grating 122 constituting a detection unit and is split into spectra of wavelengths. The spectra of wavelengths of light are condensed by an imaging lens 123, and intensities of light at individual positions (wavelengths) are converted by the line sensor into voltages.

An interference pattern of a spectrum region on a wavelength axis is observed on the line sensor 123.

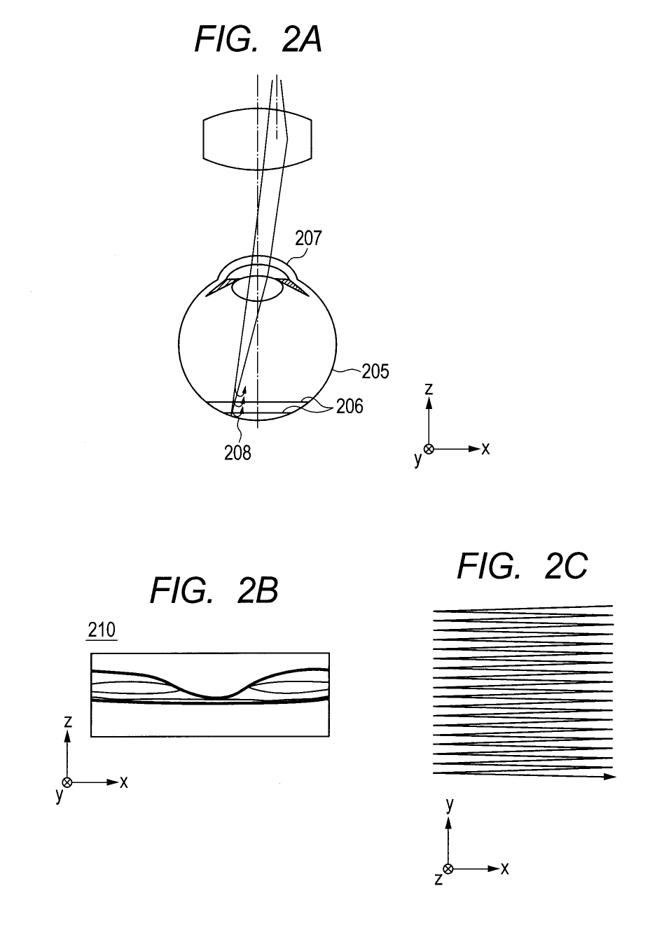

Hereinafter, acquisition of a tomographic image using the OCT apparatus is described. Here, acquisition of a tomographic image of a retina (in a plane parallel to the optical axis) is described with reference to FIGS. 2A and 2B. FIG. 2A illustrates a manner in which the eye 205 to be inspected is observed by the OCT apparatus 100. A component that is the same or corresponding to the component illustrated in FIG. 1 is denoted by the same reference numeral, and therefore the overlapping description is omitted.

As illustrated in FIG. 2A, the measuring light enters a retina 206 through a cornea 207 and is reflected or scattered at various positions to become return light 208, which reaches the line sensor 124 with delay time corresponding to the positions. In FIG. 2A, for easy understanding, the return light 208 is illustrated with a shifted axis, but actually, the return light 208 is light returning along the same optical path as the measuring light in the opposite direction. Here, a bandwidth of the light source 101 is wide and a space coherence length is short, and hence the line sensor 124 can detect the interference pattern only in the case where the optical path length of the reference optical path is substantially the same as the optical path length of the measuring optical path. As described above, what the line sensor 124 acquires is the interference pattern in the spectrum region on the wavelength axis. Next, the interference pattern as information on the wavelength axis is converted into an interference pattern on the optical frequency axis considering characteristics of the line sensor 124 and the transmission diffraction grating 123. Further, an inverse Fourier transform of the converted interference pattern on the optical frequency axis is performed so that information in the depth direction is obtained.

Further, an X axis of the XY scanner 203 is driven while the interference pattern is detected so that the interference pattern can be obtained for each position on the X axis. In other words, information in the depth direction can be obtained for each position on the X axis.

As a result, a two-dimensional distribution of intensity of the return light 208 in the XZ plane is obtained, which is a tomographic image 210 (FIG. 2B). As described above, the tomographic image 210 is essentially a distribution of intensity of the return light 208 arranged like an array, in which the intensity is displayed as a gray scale. Here, only the boundaries of the obtained tomographic image are emphasized and displayed.

In addition, as illustrated in FIG. 2C, when the XY scanner 203 is controlled so that raster scan of the retina is performed with the measuring light, a tomographic image of an arbitrary point on the retina can be acquired. Here, FIG. 2C illustrates a case where the scanning is performed in which a main scanning direction of the XY scanner is an X axis direction while a sub scanning direction is a Y axis direction. As a result, tomographic images of a plurality of XZ planes can be acquired.

Next, a method of acquiring a tomographic image is described specifically.

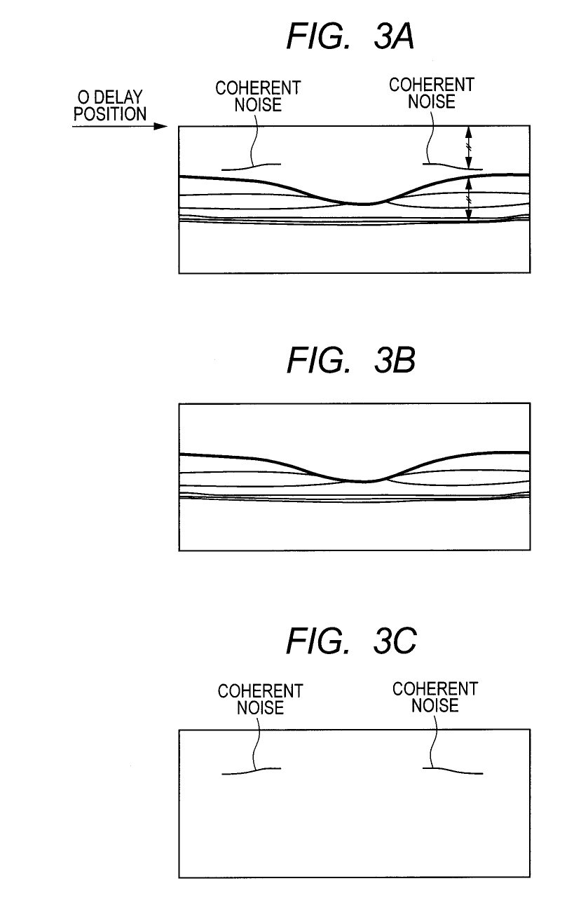

FIGS. 3A to 3C illustrate schematic diagrams of a fundus tomographic image. FIG. 3A is a schematic diagram in a case where coherent noise appears in the tomographic image, FIG. 3B is a schematic diagram in a case where coherent noise does not appear in the tomographic image. The coherent noise appearing in FIG. 3A is generated as an artifact at a position apart by a distance between high reflection layers from a position where the measuring light and the reference light have the same optical path length in the tomographic image (0 delay position, which is the upper part of the tomographic image in the case of FIG. 3A), when interference occurs between high reflection layers in the fundus. Here, examples of the high reflection layer include layers of an internal limiting membrane (ILM), a photoreceptor inner/outer segment junction line (IS/OS), and a retinal pigment epithelium (RPE), when a fundus tomographic image is acquired. The position indicating the high reflection is different depending on a place and coherent noise has a feature that there is a place where coherent noise occurs and a place where coherent noise does not occur in one tomographic image as illustrated in FIG. 3A. In addition, coherent noise also has a feature that coherent noise occurs by interference only in the measuring optical path, and appears even in a state in which the reference light is blocked. FIG. 3C illustrates an image acquired only by the measuring light by blocking the reference light. The reference light is blocked, and hence a fundus tomographic image based on interference between the measuring light and the reference light is not acquired, and coherent noise is detected.

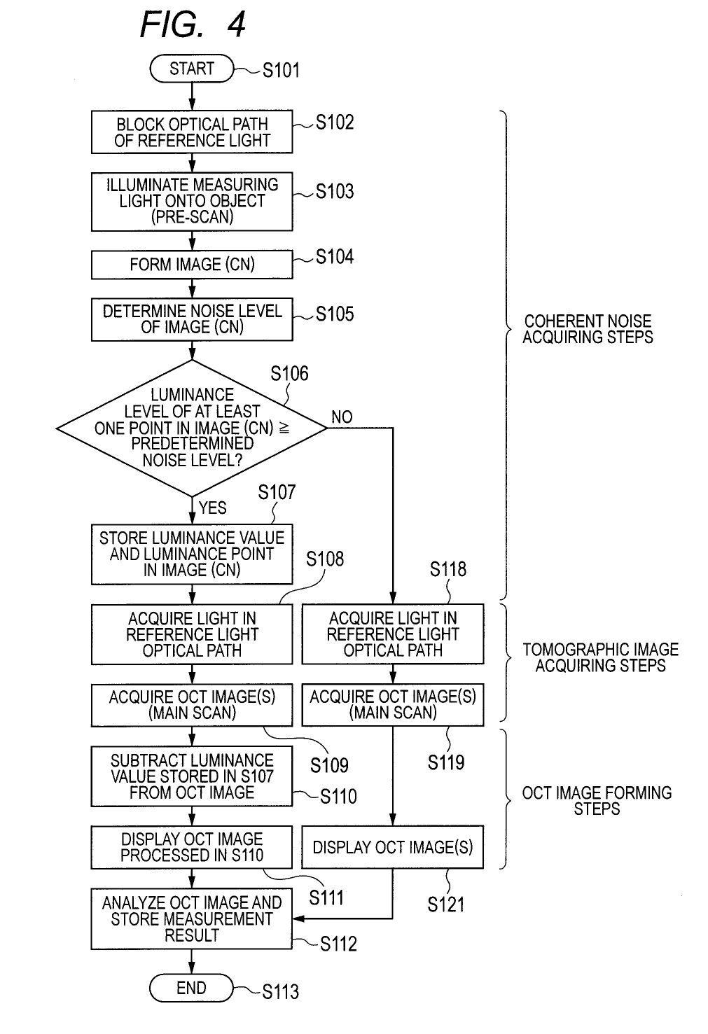

FIG. 4 illustrates a measurement flow in this embodiment.

In Step S101, the measurement is started. This state is a state in which the OCT apparatus is started, and measurement parameters necessary for the measurement such as a measurement range and position on the retina, a scan pattern, the number of pixels to be acquired, and the number of layers to be superimposed are determined.

Steps S102 to S107 are coherent noise acquiring steps for acquiring coherent noise. In addition, Steps S108 and S109 and Steps S118 and S119 are tomographic image acquiring steps for acquiring a tomographic image of a retina, and Steps S110 and S111 and Step S121 are OCT image forming steps for finally forming an OCT image.

In Step S102, through use of the light blocking portion 110, the reference light is blocked. The light blocking portion 110 includes a blocking member such as a shutter. By blocking the reference light, only the return light of the measuring light enters the spectroscope 120.

In Step S103, the XY scanner 203 is driven so that the measuring light scans the retina of the eye 205 to be inspected. The scan of this step is a pre-scan in which the reference light is blocked, and hence the pre-scan is used in distinction from a main scan in the tomographic image acquiring steps of Steps S108 and S109 and Steps S118 and S119. It is preferred that the pre-scan have the same scan pattern as the main scan. However, if the eye 205 to be inspected is known in a case of remeasurement or follow-up, a position of coherent noise can be expected. A position where coherent noise appears depends on a distance between high reflection layers in the retina 206. Therefore, if the high reflection layers in the retina 206 are known, a position of coherent noise can be determined from an interval between the high reflection layers. Thus, it is possible to eliminate the two-dimensional scan by an XY scan and to perform the pre-scan only in one tomographic image by an X or Y scan.

In Step S104, an image (CN) is formed only by the measuring light. The return light from each point on the retina scanned in Step S103 is detected by the spectroscope 120 so that the interference pattern is obtained for each position of each point. Usually, in acquisition of a tomographic image of a retina, the combined light in which the return light of the measuring light and the reference light are combined is input to the spectroscope 120 so as to form an image. In this Step S104, however, an image is formed only by the return light of the measuring light. The obtained interference pattern is converted into an interference pattern on the optical frequency axis, and an inverse Fourier transform of the converted interference pattern on the optical frequency axis is performed so as to obtain an image for calculating coherent noise of each point. Thus, the image (CN) illustrated in FIG. 3C can be acquired.

There is a plurality of reflection layers in the fundus portion as the object to be inspected. As to the return light generated when the measuring light is reflected by the plurality of reflection layers, the artifact, namely, the coherent noise is generated by interference between reflected light beams due to the high reflection layers.

In Step S105, a noise level for judging presence or absence of coherent noise in the image (CN) is determined. Determination of a noise level is described below. First, a noise acquisition region in the image (CN) is determined. It is preferred that the noise acquisition region have a position where a coherence noise does not appear. Supposing that a thickness of the retina that can be observed by the OCT is approximately 1 mm, the noise acquisition region is set at a position apart from the position where the coherent noise appears by at least 1 mm, preferably more than 1.5 mm. An average value in the noise acquisition region is determined as a noise level. In addition, when the image is acquired a plurality of times, a noise level is the same level among the plurality of images, and hence it is possible to set a noise level of one image as a noise level of the plurality of images instead of determining a noise levels for the individual images.

In Step S106, it is judged whether or not there is a luminance of a noise level or higher determined in Step S105 in the image (CN). If there is a luminance of a noise level or higher in the image (CN), the noise is judged to be the coherent noise, and the process proceeds to a step of removing the coherent noise. If there is no luminance of a noise level or higher, it is not necessary to remove the coherent noise, and hence the coherent noise is not removed. By performing this step, it is possible to shorten a process time by eliminating the step of removing coherent noise despite the fact that there is no coherent noise.

In addition, it is also not necessary to store the luminance and a place of the coherent noise described in the next step, and hence it is possible to save a memory. If it is judged that there is coherent noise, the process proceeds to Step S107. If it is judged that there is no coherent noise, the process proceeds to Step S118.

In Step S107, the position and the luminance value of the luminance judged to be a noise level or higher in Step S105 are acquired from the image (CN) and are stored. A storage unit is, for example, a memory of the PC.

Elements concerning the operation described above for acquiring the coherent noise, namely the artifact, constitute an artifact acquiring unit in the present invention. Therefore, in this embodiment, the structure of light blocking portion 110 for blocking the reference optical path and its accompanying structures are included in the artifact acquiring unit. In other words, in this embodiment, the artifact acquiring unit described above acquires the artifact from the image of the object to be inspected obtained in the state in which the light blocking portion 110 blocks the reference light and the image of the object to be inspected obtained in the state in which the light blocking portion is removed from the optical path so that the reference light can be transmitted. In addition, the operation described above corresponds to a step of acquiring artifact in the present invention, namely a step of acquiring artifact by comparing at least two tomographic images obtained from the same region by different conditions of the reference light.

In Step S108, the light blocking portion 110 is set to the state in which the light can be transmitted, in which the reference light can enter the line sensor 124. Thus, the combined light of the return light of the measuring light and the reference light enters the spectroscope 120 so that the tomographic image of the retina can be acquired.

In Step S109, an OCT image (S) is acquired. In this step, the main scan is performed in contrast of the pre-scan in Step S103. The main scan is performed with the measurement parameters determined in S101. The XY scanner 203 is driven, and the measuring light scans the retina of the eye 205 to be inspected. The return light from each point on the scanned retina and the reference light are combined to make the combined light, and the combined light is detected by the spectroscope 120 so that the interference pattern is obtained for each position of each point on the retina. The obtained interference pattern is converted into an interference pattern on the optical frequency axis, and the inverse Fourier transform of the converted interference pattern on the optical frequency axis is performed so that the tomographic image of each point can be obtained. In this step, the tomographic image illustrated in FIG. 3A is obtained, and coherent noise is included in the image.

In Step S110, the tomographic image without the coherent noise is obtained from the tomographic image acquired in Step S110 based on the information of the coherent noise stored in S107. As for the image acquired in Step S110, the OCT image without the coherent noise can be obtained by subtracting a luminance value at the position stored in Step S107 from the image (S) including the coherent noise. By subtracting the image of FIG. 3C from the image of FIG. 3A, the image of FIG. 3B can be acquired.

In Step S111, the OCT image acquired in Step S110 is displayed on a preview screen or the like. Note that, the display is performed by a display control unit constituted of the above-mentioned PC, and in this display, it is possible to display the coherent noise or the artifact having a luminance of a predetermined luminance value or higher in a superimposing manner with a red color, for example. Alternatively, it is possible to display the part corresponding to the noise with a red color or the like superimposed on the tomographic image before removing the coherent noise, or to display the tomographic image after removing the noise and the tomographic image before removing the noise side by side. Alternatively, the display of the tomographic image after the noise reduction processing can be switched to the display of the tomographic image before the noise reduction processing. In such display switching, the depression of switch and the like by an user can execute the switching, or it can be execute after predetermined time passage such as time passage of an analysis time interval for the noise reduction from the display of the tomographic image before the noise reduction. Furthermore, in the display of the tomographic image after the noise reduction, a display aspect designating an execution of the noise reduction process can be displayed with the tomographic image so as to improve the convenience of the user. These displays are performed by the above-mentioned display control unit. With this structure, an operator can easily distinguish the coherent noise in the tomographic image.

On the other hand, if it is judged in Step S106 that there is not a luminance of a noise level or higher in the image CN (there is no coherent noise), the light blocking portion 110 is set to the state in which the light can be transmitted in Step S118 similarly to Step S108 so that the reference light is acquired.

In other words, in this embodiment, the above-mentioned control unit 130 determines a noise level of the image of the object to be inspected. If the image of the object to be inspected has a luminance value of a noise level or higher, the control unit 130 stores the luminance value of a noise level or higher and a position in the tomographic image indicating the luminance value, and further subtracts the luminance value corresponding to the position stored previously in a first tomographic image of the object to be inspected.

Next, in Step S119, the OCT image (S) is acquired similarly to Step S109. In Step S121, the OCT image obtained in Step S119 is displayed, and the process proceeds to Step S112. In Steps S118 to S121, it is judged that there is no coherent noise, and hence it is not necessary to include the step of removing the coherent noise.

In Step S112, an OCT image analysis such as segmentation, layer thickness measurement, and comparison with data of a healthy eye is performed, and a result of the measurement is stored. The operations described above correspond to the steps of the present invention in which the artifact is subtracted from the tomographic image of the object to be inspected so as to obtain a new tomographic image, which is at least displayed, stored, or analyzed. These steps are performed by the control unit 130 of the present invention.

In Step S113, the measurement is ended.

The above-mentioned operation of subtracting the coherent noise from the tomographic image, displaying the OCT image obtained from the operation, storing the OCT image, or analyzing the OCT image by obtaining a new tomographic image is performed by the control unit of the present invention, and the control unit is constituted of the above-mentioned PC or the like.

In this measurement flow, the coherent noise acquiring steps of Steps S102 to S107 are performed, and then the tomographic image acquiring steps of Steps S108 and S109 are performed. However, the coherent noise acquiring steps and the tomographic image acquiring steps may be performed in the opposite order. Specifically, it is possible to acquire the OCT image (S) first, and then to acquire the coherent noise by blocking the light in the reference optical path, so as to subtract the coherent noise from the OCT image (S). In other words, as to first and second tomographic images of the object to be inspected, it is only necessary to acquire one of the images first, and then to acquire the other image.

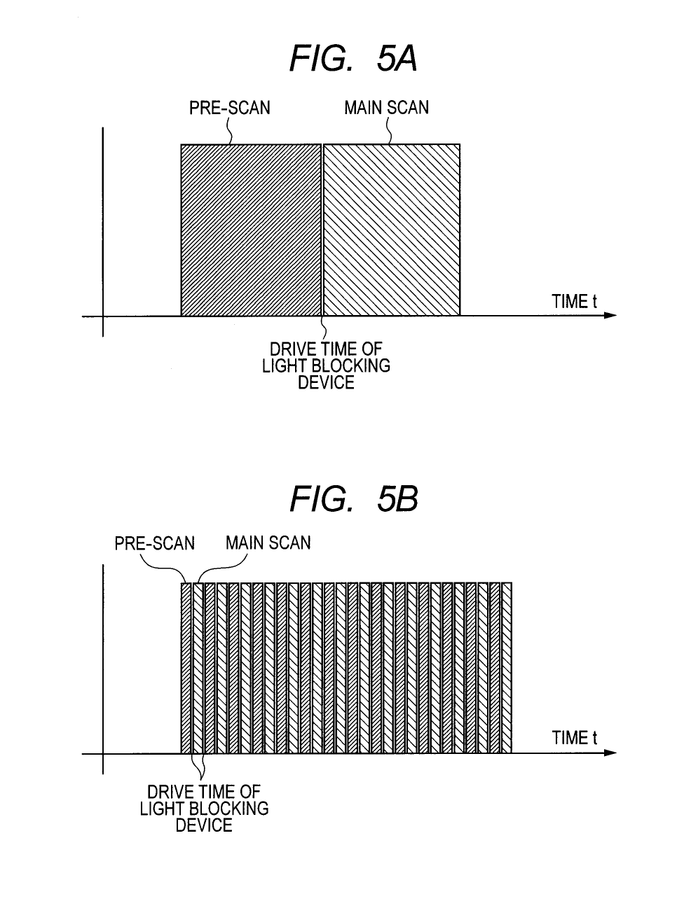

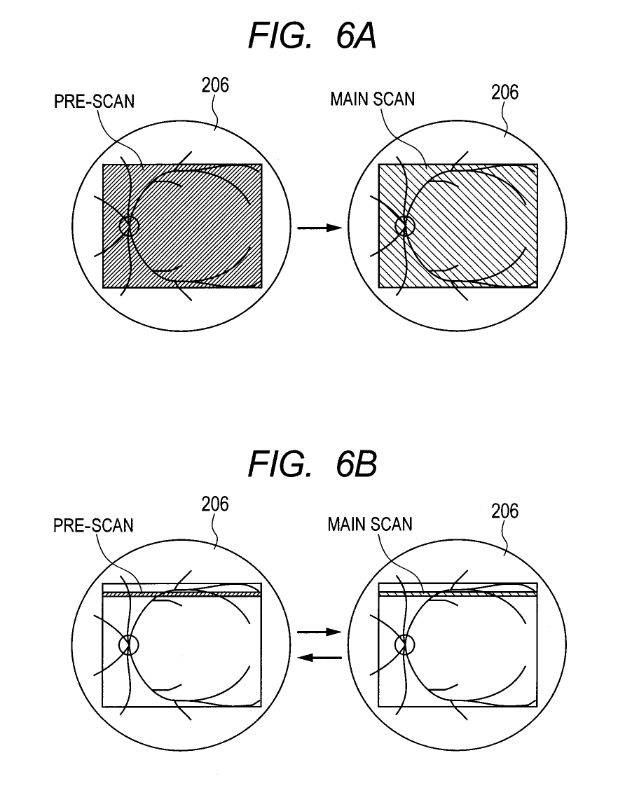

In addition, it is possible to change acquisition timings of the pre-scan and the main scan. FIGS. 5A and 5B illustrate timing charts. FIG. 5A is a timing chart of the above-mentioned flow. After acquiring the coherent noise, the main scan is performed so that the coherent noise is removed. A period of time between the pre-scan and the main scan is a drive time of the light blocking portion 110. FIG. 6A illustrates a schematic diagram of the pre-scan and the main scan of the above-mentioned flow. The circular part is the retina 206. In the OCT acquisition region on the retina 206, the two-dimensional pre-scan is performed, and then the main scan is performed in a two-dimensional manner.

On the other hand, FIG. 5B illustrates a timing chart in a case where the measurement is performed by sequentially switching the pre-scan and the main scan. Neighboring pre-scan and main scan acquire the same position. After measuring the pre-scan and the main scan at the same position, the scanner 203 is driven so as to acquire another position. In other words, as to the artifact and the first tomographic image of the object to be inspected, a part of one of the images and then a part of the other image are repeatedly acquired. In this case, each of the parts is a region designated in advance, and the tomographic image corresponds to the region.

Similarly to FIG. 5A, a period of time between the pre-scan and the main scan is a drive time of the light blocking portion 110. As illustrated in FIG. 5B, when the measurement is performed by sequentially switching the pre-scan and the main scan, the number of driving of the light blocking portion 110 becomes larger and a total measurement time becomes longer than in the case illustrated in FIG. 5A. However, a time difference between the pre-scan and the main scan is small, and hence a relative deviation between the OCT apparatus 100 and the eye 205 to be inspected such as involuntary eye movement becomes smaller. Therefore, a deviation between the pre-scan and the main scan becomes small so that accuracy of removing the coherent noise is enhanced, which is a feature of this method. FIG. 6B illustrates a schematic diagram in the case where the measurement is performed by sequentially switching the pre-scan and the main scan. For instance, after finishing the pre-scan in one B-scan, the main scan of the same position is performed. After that, the B-scan position is shifted and the pre-scan is performed again. Those steps are repeated so that the coherent noise can be removed.

Note that, in this embodiment, the light blocking portion 110 completely blocks the reference light so as to judge presence or absence of the coherent noise and to acquire the coherent noise. However, in this embodiment, the same effect can be obtained also by decreasing intensity of the reference light to a state in which the coherent noise can be separated. Therefore, it is possible to temporarily change the optical path of the reference light so as to stop generating the combined light. In addition, an ND filter or the like may be inserted in the optical path to reduce intensity of light so as to generate a state in which the coherent noise can be easily acquired. Therefore, it is preferred that the above-mentioned light blocking portion be defined as a light reduction unit for decreasing intensity of the reference light. In such case, above described Step S108 is directed to a process of stopping decreasing the intensity of the reference light.

### Second Embodiment

### Acquiring a Vertical Image from Coherent Noise by Varying an Optical Path Length of a Reference Light

In the first embodiment, the light blocking portion 110 disposed in the reference optical path is used for removing the coherent noise. In a second embodiment of the present invention, the coherent noise is removed by driving the reference mirror 113 instead of using the light blocking portion 110.

A structure of an OCT apparatus of this embodiment is the same as that of the first embodiment illustrated in FIG. 1, and therefore description thereof is omitted. However, it is possible to adopt a structure without the light blocking portion 110.

Here, a method of acquiring a tomographic image is described specifically.

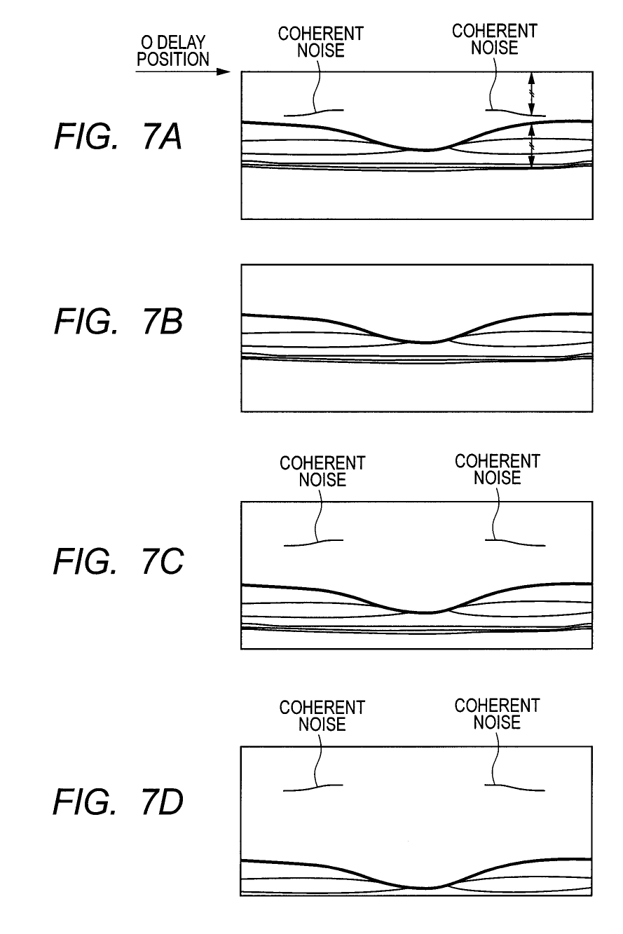

FIGS. 7A and 7B illustrate schematic diagrams of a fundus tomographic image. FIG. 7A is a schematic diagram in a case where coherent noise appears in the tomographic image, and FIG. 7B is a schematic diagram in a case where coherent noise does not appear in the tomographic image. The coherent noise is generated as an artifact at a position apart from the 0 delay position in the tomographic image by a distance between high reflection layers when interference occurs between the high reflection layers in the fundus. Therefore, a position of the coherent noise is constant regardless of a position of the reference mirror 113. On the other hand, the tomographic image of the retina 205 changes in position in the OCT image when a position of the reference mirror 113 changes. FIG. 7C and FIG. 7D illustrate the OCT images obtained when a position of the reference mirror 113 is changed. Although a position of the tomographic image of the retina changes, a position of the coherent noise is not changed, as shown in FIGS. 7C and 7D. Therefore, it is possible to acquire the coherent noise by comparing the OCT image obtained when a position of the reference mirror 113 is changed, so as to detect a fixed image.

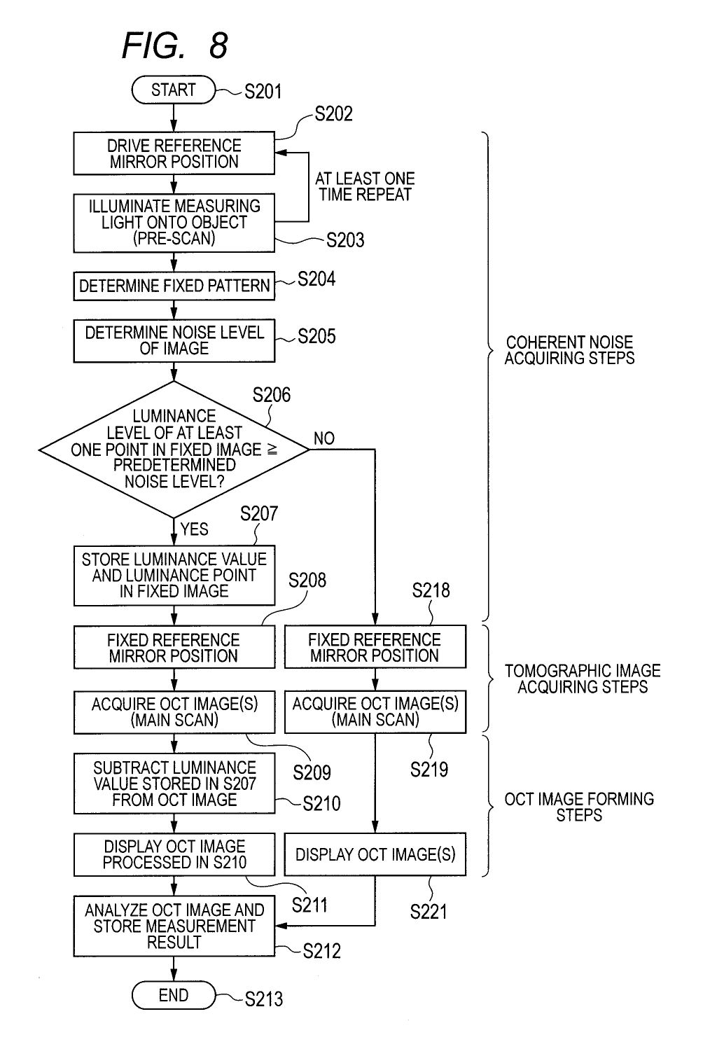

FIG. 8 illustrates a measurement flow in this embodiment.

In Step S201, the measurement is started. This state is a state in which the OCT apparatus is started, and measurement parameters necessary for the measurement such as a measurement range and position on the retina, a scan pattern, the number of pixels to be acquired, and the number of layers to be superimposed are determined.

Steps S202 to S207 are coherent noise acquiring steps for acquiring coherent noise. In addition, Steps S208 and S209 and Steps S218 and S219 are tomographic image acquiring steps for acquiring a tomographic image of a retina, and Steps S210 and S211 and Step S221 are OCT image forming steps for finally forming an OCT image.

In Step S202, the reference mirror 113 is driven. By driving the reference mirror, the tomographic image at a certain reference light position can be obtained. Here, the tomographic image of the retina 206 may not be observed in the image.

In Step S203, the XY scanner 203 is driven so that the measuring light scans the retina of the eye 205 to be inspected. The scan of this step is a pre-scan which is used in distinction from a main scan in the tomographic image acquiring steps of Steps S208 and S209 and Steps S218 and S219. It is preferred that the pre-scan have the same scan pattern as the main scan. However, if the eye 205 to be inspected is known in a case of remeasurement or follow-up, a position of coherent noise can be expected. Thus, it is possible to eliminate the two-dimensional scan by an XY scan and to perform the pre-scan only in one tomographic image by an X or Y scan. Estimation of the position of the coherent noise is as described above.

Here, it is necessary to perform Step S202 and Step S203 a plurality of times. The plurality of times of measurements need to be performed with different positions of the reference mirror 113.

In Step S204, the pre-scan images acquired with different reference mirror positions are compared with each other so that a fixed pattern is detected. For instance, a correlation coefficient among a plurality of images is acquired, and only an image having high correlation is acquired so that the fixed pattern is detected. In addition, subtraction is performed among a plurality of images, and an image that becomes a noise level by the subtraction is acquired so that the fixed pattern is detected.

In Step S205, a noise level is determined from the pre-scan image obtained in S203.

Determination of a noise level is as described above.

In Step S206, it is judged whether or not the fixed pattern detected in Step S204 has a luminance of the noise level or higher determined in Step S205. If the fixed pattern has a luminance of the noise level or higher, the noise is judged to be the coherent noise, and the process proceeds to the step of removing the coherent noise. If the fixed pattern does not have a luminance of the noise level or higher, because it is not necessary to remove the coherent noise, the coherent noise is not removed. An advantage of performing this step is as described above for Step S106 in the first embodiment.

In this embodiment, the above-mentioned artifact acquiring unit includes the reference mirror 113 as an optical path length changing unit for relatively changing the optical path lengths of the measuring optical path and the reference optical path, and acquires the artifact from two interference signals obtained from at least two reference optical path lengths set by the optical path length changing unit. Here, the optical path length changing unit is the reference mirror 113, but the changing unit only needs to relatively or simply change an optical path length difference between the measuring optical path and the reference optical path. It is therefore possible to dispose the optical path length changing unit in the measuring optical path. In this case, the artifact acquiring unit acquires the artifact from at least two interference signals corresponding to at least two optical path length differences.

In Step S207, the position and the luminance value of the fixed pattern judged to be a noise level or higher in S205 are stored. A storage unit is a memory of the PC or the like.

In Step S208, the reference mirror 113 is fixed to a position suitable for acquiring the tomographic image of the retina 206. The reference mirror may be moved automatically until a period of the interference pattern detected by the spectroscope 120 matches a certain position, or may be moved manually by the operator while observing the tomographic image.

If it is judged in Step S206 that the fixed pattern does not have a luminance of a noise level or higher, the process proceeds to S218.

In this embodiment, the above-mentioned control unit determines noise levels of at least two interference signals. If there is a luminance of the determined noise level or higher, the above-mentioned operation is performed in which the luminance value of the noise level or higher and the position having the luminance value in the image are stored, and the stored luminance value at the stored position is subtracted from the tomographic image of the object to be inspected.

In Step S218, similarly to S208, the reference mirror 113 is fixed to a position suitable for acquiring the tomographic image of the retina 206.

Here, Steps S209 to S213 of measurement end and Steps S219 to S221 are the same as Steps S109 to S113 of measurement end and Steps S119 to S121 in the first embodiment. Therefore, individual descriptions are omitted.

Also in this embodiment, the coherent noise acquiring steps of Steps S202 to S207 are performed, and then the tomographic image acquiring steps of Steps S208 and S209 are performed. However, the coherent noise acquiring steps and the tomographic image acquiring steps may be performed in the opposite order. Specifically, it is possible to acquire the OCT image (S) first, and then detect the fixed pattern by moving the position of the reference mirror, so as to subtract the coherent noise from the OCT image (S).

Note that, this embodiment has exemplified the case where the control unit 130 moves the reference mirror 113 to change the optical path length of the reference optical path, but the same effect can be obtained in a case where the optical path length of the measuring optical path is changed. Therefore, the change of the optical path length in the present invention should be understood as a relative change of the optical path lengths between the reference optical path and the measuring optical path, and it is sufficient that the optical path length changing unit changes any one of the optical path length of the optical paths.

### Other Embodiments

In addition, the present invention can be also realized by performing the following process. Specifically, in the process, software (program) realizing the functions of the above-mentioned embodiments is supplied to a system or an apparatus via a network or various storage media, and a computer (CPU or MPU) of the system or the apparatus reads and executes the program.

In addition, the embodiments described above have exemplified a human eye as the object to be inspected and in particular a retina as a multilayered membrane. However, the present invention is not limited to the embodiments but can be applied to the optical tomographic imaging apparatus or method for various objects to be inspected having a multilayered membrane. For instance, it is considered to apply the present invention to an image pickup apparatus such as an endoscope other than an ophthalmologic apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2011-077091, filed Mar. 31, 2011, and No. 2012-063897, filed Mar. 21, 2012, which are hereby incorporated by reference herein in their entirety.

What is claimed is:

1. An optical tomographic imaging apparatus for acquiring a tomographic image of an object to be inspected based on combined light in which return light from the object to be inspected that is illuminated by measuring light and reference light corresponding to the measuring light are combined, the optical tomographic imaging apparatus comprising:
an artifact acquiring unit for acquiring an artifact generated by interference among a plurality of reflected light beams reflected by a plurality of layers of the object to be inspected; and
an acquiring unit for acquiring a second tomographic image of the object to be inspected based on the artifact and a first tomographic image of the object to be inspected.

2. An optical tomographic imaging apparatus according to claim 1, further comprising a light reduction unit disposed in an optical path of the reference light, for decreasing intensity of the reference light,
wherein the artifact acquiring unit acquires the artifact from an image obtained in a state in which the intensity of the reference light is decreased by the light reduction unit.

3. An optical tomographic imaging apparatus according to claim 2, wherein the light reduction unit includes a light blocking portion that is insertable and removable from the optical path of the reference light, for blocking the reference light when being inserted.

4. An optical tomographic imaging apparatus according to claim 2, wherein the light reduction unit decreases the intensity of the reference light after the first tomographic image is acquired and stops decreasing the intensity of the reference light after the artifact is acquired.

5. An optical tomographic imaging apparatus according to claim 1, further comprising a control unit configured to:
determine a noise level of the artifact of the object to be inspected;
store, when the artifact has a position indicating a luminance value at the determined noise level or higher, the luminance value of the noise level or higher and the position having the luminance value; and
subtract the stored luminance value at the stored position from the first tomographic image of the object to be inspected.

6. An optical tomographic imaging apparatus according to claim 5, wherein the control unit acquires one of the first tomographic image and the artifact, and then acquires another of the first tomographic image and the artifact.

7. An optical tomographic imaging apparatus according to claim 5, wherein the control unit repeatedly acquires a part of one of the first tomographic image and the artifact and then acquires a part of another of the first tomographic image and the artifact, each of the parts being a designated region, the first tomographic image corresponding to an image of the designated region.

8. An optical tomographic imaging apparatus according to claim 1, further comprising a changing unit for changing an optical path length difference between an optical path of the measuring light and an optical path of the reference light,
wherein the artifact acquiring unit acquires the artifact from at least two interference signals corresponding to at least two optical path length differences, respectively.

9. An optical tomographic imaging apparatus according to claim 5, wherein the control unit is configured to:
determine noise levels of the at least two interference signals;
store, when the image has a position indicating a luminance value of the determined noise level or higher, the luminance value of the noise level or higher and the position having the luminance value in the image; and
subtract the stored luminance value at the stored position from the first tomographic image of the object to be inspected.

10. An optical tomographic imaging apparatus according to claim 1, further comprising a display control unit for controlling a display unit to display a display form indicating the artifact.

11. An optical tomographic imaging apparatus according to claim 1, further comprising a display control unit for controlling a display unit to display the second tomographic image of the object to be inspected, which is obtained by reducing the artifact, after a predetermined time passage from a display of the first tomographic image.

12. A method of controlling an optical tomographic imaging apparatus for acquiring a tomographic image of an object to be inspected based on combined light in which return light from the object to be inspected that is illuminated by measuring light and reference light corresponding to the measuring light are combined, the method comprising:
acquiring an artifact generated by interference among a plurality of reflected light beams reflected by a plurality of layers of the object to be inspected; and
acquiring a second tomographic image of the object to be inspected based on the artifact and a first tomographic image of the object to be inspected.

13. A method of controlling an optical tomographic imaging apparatus according to claim 12, wherein the acquiring an artifact includes acquiring an image from the return light in a state in which intensity of the reference light is decreased, and acquiring the artifact based on the image.

14. A method of controlling an optical tomographic imaging apparatus according to claim 12, wherein the acquiring an artifact includes acquiring the artifact based on at least two interference signals obtained when an optical path length difference between an optical path of the reference light and an optical path of the measuring light is changed.

15. A medium in which a program for causing a computer to perform the steps of the method of controlling an optical tomographic imaging apparatus according to claim 12 is stored.
